(19) United States
(12) Patent Application Publication
(10) Pub. No.: US 2010/0199100 A1
(43) Pub. Date: Aug. 5, 2010

(54) Secure Access by a User to a Resource

(76) Inventor: Norman Frank Goertzen, Winnipeg (CA)

Correspondence Address: ADE & COMPANY INC., 2157 Henderson Highway, WINNIPEG, MB, R2G1P9, CA

(21) Appl. No.: 12/696,310

(22) Filed: Jan. 29, 2010

Related U.S. Application Data
(63) Continuation-in-part of application No. 11/214,137, filed on Aug. 29, 2005, now Pat. No. 7,689,831.
(60) Provisional application No. 60/605,646, filed on Aug. 30, 2004.

(51) Int. Cl. H04K 1/00

(52) U.S. Cl. 713/185; 726/9

(57) ABSTRACT

A method for securing interface access via visual array patterns in combination with hidden operations improves the security of computer systems and dedicated terminals. A hint display is generated in at least a quasi-random fashion that may be an array of numerical digit values. A user input token is received that represents selection of a pattern of elements chosen from the hint display and combined in an algorithm using one or more mathematical, relational and/or logical operations. A pre-defined pattern and algorithm are used to generate a token from the hint display that is compared with the user input to verify that the user knows the pattern and algorithm. Further ease of use can be provided by dividing a hint display array into sub-arrays while providing a clue such as color to indicate each sub-array to the user.

This application is a continuation in part application of non-provisional application Ser. No. 11/214,137 filed Aug. 29, 2005 and claims priority under 35 USC 119 from Provisional Application 60/605,646 filed Aug. 30, 2004, the disclosure of which is incorporated herein by reference.

The present invention relates generally to graphical/textual user interfaces, and more specifically, to a method and system for securing machine interface access.

### BACKGROUND OF THE INVENTION

Computer systems and dedicated devices such as automated teller machines (ATMs) increasingly provide access to interfaces that must be protected from unauthorized use. Typical security on such user interfaces is provided by a password or “personal identification number” PIN) that must be provided to the user interface via an input device prior to further access by an individual (or in some instances another machine) accessing the interface.

The level of security provided by a “weak” password or token such as a password or PIN is generally related to its length and arbitrariness. However, the same factor is also determinative of the difficulty for a human to remember the token. Also, the number of possible token element values, e.g., just digits versus digits plus letters is generally made larger to improve security, but the input set size increase is generally either thwarted by use of common words or numbers within the total possible space of values.

While it is possible to provide “hints” to a user that will stimulate a recollection of the token, such hints also provide a potential security breach in that the token may be discoverable via guessing once the hint is given. Other systems include a secondary password that has some concrete meaning to the token owner that can be used to reveal the actual token. For example, an interface may use the users mother's maiden name or “favorite animal”, etc. as a secondary token to protect the underlying access token if the user forgets.

Two-dimensional textual or graphical hint systems have been proposed, from systems that actually display the password in a form such as a “hidden word” puzzle to systems that use a randomized arrangement of icons that must be selected in order or a particular arrangement of icons that must be selected in a pattern in order to satisfy token entry. All of the above systems have an advantage in that they are not easily overcome by mere repetitive machine input.

However, all of the above systems may reveal their underlying token eventually through human observation, especially when the underlying token hiding mechanism is known a priori. For example, if it is known that the token hiding mechanism is a particular arrangement of icons that must be selected in a pattern, an observer can ignore the actual icons and merely note the pattern.

A token system having improved “strength” can rely on a smaller set of element input values, can use longer-lived passwords and/or can be used across multiple systems without the same risk of compromise as weaker passwords.

Therefore, it would be desirable to provide a method and system for hiding tokens in a hint display that cannot be easily discovered through observation of token entry patterns and values.

### SUMMARY OF THE INVENTION

The above objective of hiding tokens in a hint display that cannot be easily discovered through observation of token entry is achieved in a method and system.

The method and system displays a hint display of a plurality of elements forming a set of the elements that includes a smaller plurality or subset of elements each having a value and a position, which may be an array of numerical digits. That is each of the elements of the subset has a character which can be determined by the user allowing the user to carry out an operation on the characters. The method and system thus receives a sequence of user input corresponding to selected patterned sequence of the displayed elements combined in an algorithm or operation using one or more operators to perform one or more operations on the patterned sequence.

The method and system verifies whether or not the user knows the proper pattern and algorithm or operation by computing a token from the hint display and comparing the user input to the token. Access to one or more resources of the system or for which access is controlled by the system is conditioned upon a match of the token to the user input.

The invention therefore provides a method for allowing access to a resource for a plurality of separate user sessions by a user comprising:

wherein the method is carried out by an authentication system having a user interface with a display viewable by the user and an input for entry of data by the user;

the system being arranged for each session to generate a hint display made up of a set of elements;

the set of elements including a sub-set of elements;

causing the sub-set to be predetermined prior to the sessions in communication between the system and the user;

the set of elements defining individual characters;

the characters of at least some of the elements of the set being changed for at least some of the sessions;

displaying said hint display including the set of elements to said user;

to commence a session, causing said user to compute a token from the characters of the elements of the sub-set of said hint display generated for that session;

causing said user to enter the computed token into the user interface;

causing the system to effect a comparing of said token received with at least one corresponding token generated by the authentication system;

and selectively providing access by the user to said resource for said session in conformity with a matching result of said comparing;

and during computing of the token causing said user to perform at least one operation on said character of said at least one of said elements of said predetermined sub-set such that the token comprises at least one hidden character which is not identical to the character of said at least one of said elements upon which the operation is performed.

There is therefore provided a protocol known between the user and the system by which the subset is selected, and then an operation also known between the user and the system by which the token is calculated or computed from the subset using the characters determined by that subset.

The subset may be determined in the set by displaying the set in a predetermined array and by providing the subset as a predetermined pattern in the array of selected ones of the elements of the array with each element in the predetermined pattern having a unique position characteristic in the array.

The characters may be numerical values.

The operation may be carried out by an arithmetic operation on a numerical value forming at least one of the characters.

The operators employed to compute the token from the pattern may be mathematical (including logical) operators or relational operators. One or more of the pattern elements may be excluded from the token computation, which may be conditioned upon a relational operation or by ignoring one of the pattern elements on a fixed basis.

The method may be embodied in a general-purpose computer system, a browser executing within a general-purpose computer system or a dedicated terminal. The method may also be embodied in a computer program product that encodes program instructions for carrying out the steps of the method.

In accordance with another important feature of the invention, in the method as defined above, where the subset is determined in the set by displaying the set in a predetermined array and by providing the subset as a predetermined pattern in the array of selected ones of the elements of the array with each element in the predetermined pattern having a unique position characteristic in the array, the array includes a plurality of sub-arrays where each of the sub-arrays is visually distinguished from the others.

Preferably the sub-arrays are distinguished from each other by color.

Preferably each of the sub-arrays is a 3×3 array of the positions.

In accordance with another important feature of the invention, in the method as defined above, a level of security provided to the system by the token is varied without changing the predetermined protocol or the predetermined operation.

Where the subset is determined in the set by displaying the set in a predetermined array and by providing the subset as a predetermined pattern in the array of selected ones of the elements of the array with each element in the predetermined pattern having a unique position characteristic in the array the level of security provided by the token is varied by truncating the pattern so as to reduce the length of the token.

Where the characters are numerical values allowed over a range of numerical values, the level of security provided by the token is varied by changing the range of numerical values allowed for each element.

Where the set is displayed as an array, the level of security provided by the token is varied by maintaining the array constant over a plurality of sessions.

In accordance with another important feature of the invention, in the method as defined above, a second subsidiary user is allowed to obtain access to the resource for a session by:

communicating the hint display including the set of elements for the session to the subsidiary user;

causing the subsidiary user to communicate the set of elements to the user;

causing the user to use the predetermined protocol and the predetermined operation to compute the token;

causing said user to communicate the token, without the predetermined protocol and the predetermined operation, to the subsidiary user so as to enter the computed token into the user interface;

causing the system to effect a comparing of said token received with at least one corresponding token generated by the authentication system;

and selectively providing access by the user to said resource for said session in conformity with a matching result of said comparing.

The foregoing and other objectives, features, and advantages of the invention will be apparent from the following, more particular, description of the preferred embodiment of the invention, as illustrated in the accompanying drawings.

### BRIEF DESCRIPTION OF DRAWINGS

FIG. 1 is a block diagram of a system in which an embodiment of the present invention may be practiced.

FIG. 2 is a pictorial diagram depicting a user interface in accordance with an embodiment of the present invention.

FIG. 3 is a flow chart depicting operation of a system as embodied in a method in accordance with an embodiment of the present invention.

FIG. 4 is a an illustration of arrays from three log-in procedures showing three different examples of the Array style of pattern.

FIG. 5 is a an illustration of arrays from a plurality of log-in procedures showing different examples of the Line style of pattern.

FIG. 6 is a an illustration of arrays from three log-in procedures showing three different examples of the Quadrant style of pattern.

FIG. 7 is a an illustration of arrays from six log-in procedures showing six different examples of the Shape style of pattern.

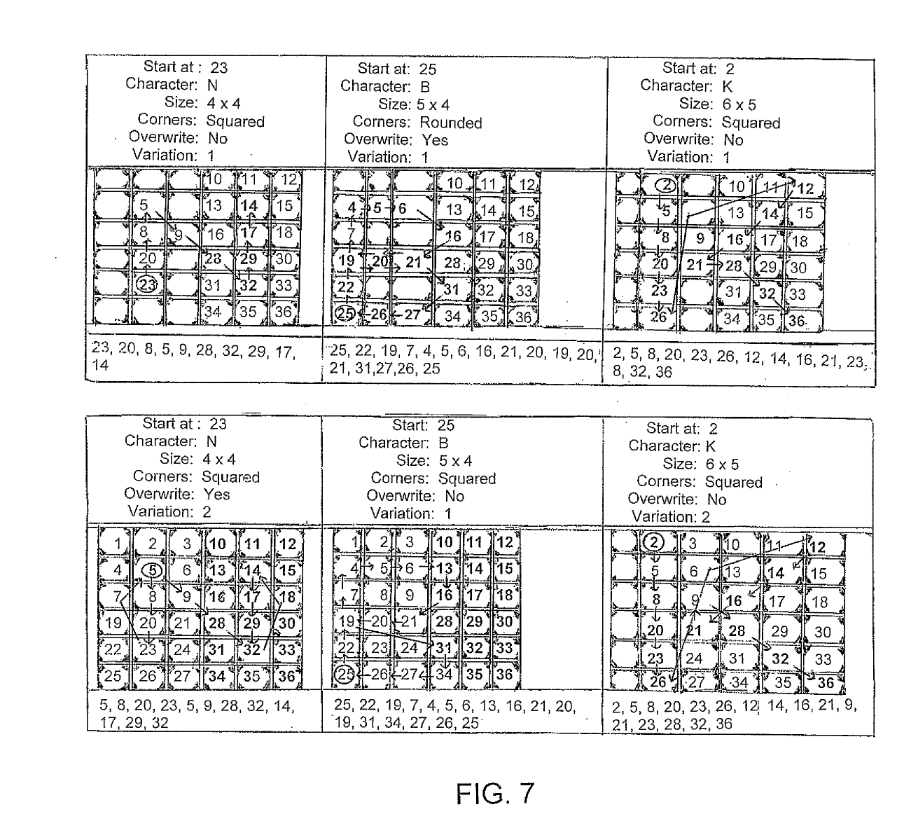

FIG. 8 is a an illustration of arrays from three log-in procedures showing three different examples of solutions for the calculation of the Token including a hacker trap.

FIG. 9 is a modified version of the system of FIG. 3 showing the identification of a hacker using a hacker trap solution.

FIG. 10 is a modified version of the system of FIG. 3 showing the one time use of the system by a subsidiary user.

FIG. 11 is a modified version of the system of FIG. 3 showing the provision of the pattern and operation to the user.

### DETAILED DESCRIPTION OF PREFERRED EMBODIMENT

The present invention provides improved security for systems accessed through entry of a token or password via a method that is implemented by execution of program instructions. The techniques are applicable to replace traditional password or PIN entry within computer systems or dedicated terminals such ATMs. In computer systems, the present invention may be employed in the operating system of a general-purpose computing system, embedded in a dedicated application, or provided via a web page interface downloaded from a server, for example via an extensible markup language (XML) program or Java script or program. The present invention in general protects access to a resource, such as a login access to a system, financial information and transactional capability at an ATM, or other secured resource such as an application or database.

Rather than merely accepting entry of a password or token and optionally processing the token to compare it to a stored value, as traditional password systems do, the present invention effectively generates a randomized token on-the-fly. The randomized token is generated via rule-based processing from a set of values selected from a hint display that is presented to the user. There are two components to the processing: 1) a pattern by which the user selects a sequence of elements from the hint display; and 2) an algorithm or operation that uses one or more operators in one or more operations performed on values produced from at least a portion of the sequence of elements in order to generate the token. The hint display can be a randomly generated set of elements bearing no pre-defined relation to the pattern or algorithm other than the values and value ranges of the elements must suitable for use with the particular algorithm employed and the pattern must fit the display. If the hint display is randomly generated as a single array or other display, then the display can be generated prior to knowing the user via a user identification code or other means. The sequence is then chosen from the appropriate positions in the hint display once the user is known. Alternatively, if the user is known prior to generating the display, the sequence can be randomly generated first and hidden at particular positions in the hint display that correspond to the positions within the above-mentioned pattern by seeding the non-patterned locations with another randomly generated set of elements.

After the sequence of elements is known, the algorithm is applied to values of the sequence of elements to generate the token, which is generally also a sequence of numbers, but may be a single number, such as a summation of all the digits in the pattern. Operators can combine any number of values from the sequence and reduce them in the output sequence or expand them in the output sequence. For example, a sum of three values from the pattern elements may represent a reduction of 3:1 in the output sequence, but a sum, product and “larger of” operator applied to two values in sequence would represent an expansion of 2:3 in the output sequence. The operators used can be mathematical (including logical) or relational, such as “the larger of” or “the smaller of” operators applied to two numbers. In general, it is not desirable to reduce the number of elements in the output sequence that provides the access token below a certain level, as a short token is easier to “guess”.

The user mimics the operation of the patterned sequence selection and the operator-based algorithm from memory and enters a token value based on the selection and mental computation.

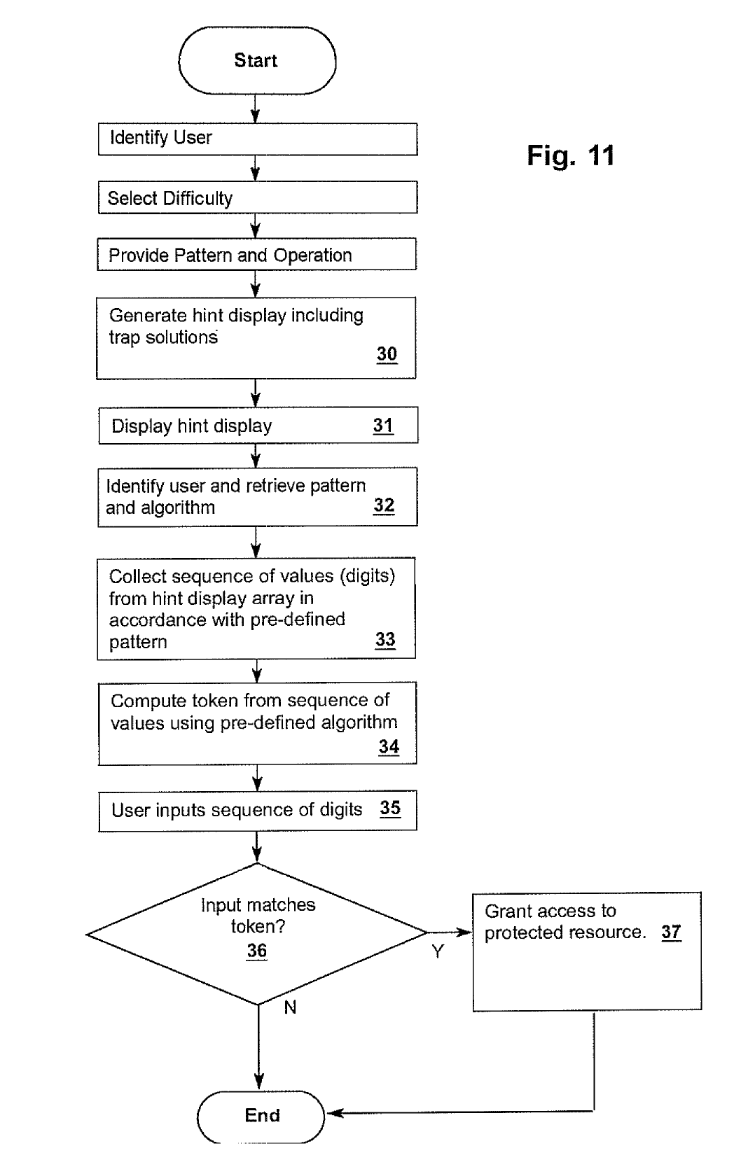

The level of complexity of the mental computation required can be adjusted as shown in FIG. 11, by selecting appropriate operators and the design of the total algorithm, which is user-settable. For example, a simple algorithm could model a horizontal line through an array of digits where the token sequence value is the lesser of each pair of digits from left to right in the line. A very complex algorithm could combine apparently random positions selected sequentially from an array of values and combine them using a different mathematical operation for each value.

Additionally, the level of security of a system can be varied in without changing the pattern and algorithm for a user. The pattern can be truncated to reduce the length of a required token, changing the range of values allowed for each element, and/or fixing the clue table as a static array. Each of the above techniques do not affect the underlying pattern and algorithm assigned to a user's security mechanism, but adapt the level of security and complexity to a particular instance of an access to a system or access to a particular system.

In other words, a level of security provided to the system by the token is varied by the system without changing the predetermined protocol provided to the user which selects the subset or without changing the predetermined operation on the values or characters so determined.

From the above it will be clear that the predetermined protocol and the predetermined operation are provided to the user by the system in communication between the system and the user. The user thus selects the degree of difficulty as it is user-settable, and, in response to the selection by the user of that degree of difficulty, the system provides to the user the protocol for the subset and the operation for the calculation of the token.

In the arrangement where the subset is determined in the set by displaying the set in a predetermined array and by providing the subset as a predetermined pattern in the array of selected ones of the elements of the array with each element in the predetermined pattern having a unique position characteristic in the array, the level of security provided by the token can be varied by truncating the pattern so as to reduce the length of the token.

In the arrangement where the characters are numerical values allowed over a range of numerical values, the level of security provided by the token can be varied by changing the range of numerical values allowed for each element.

In the arrangement where the set is displayed as an array, the level of security provided by the token can be varied by maintaining the array constant over a plurality of sessions.

Generally during computing of the token the user performs at least one operation on the character of said at least one of said elements of the predetermined sub-set such that the token comprises at least one hidden character which is not identical to the character of said at least one of said elements upon which the operation is performed. However the operation may be in some very simple cases the mere repetition of some or all of the characters determined in the subset.

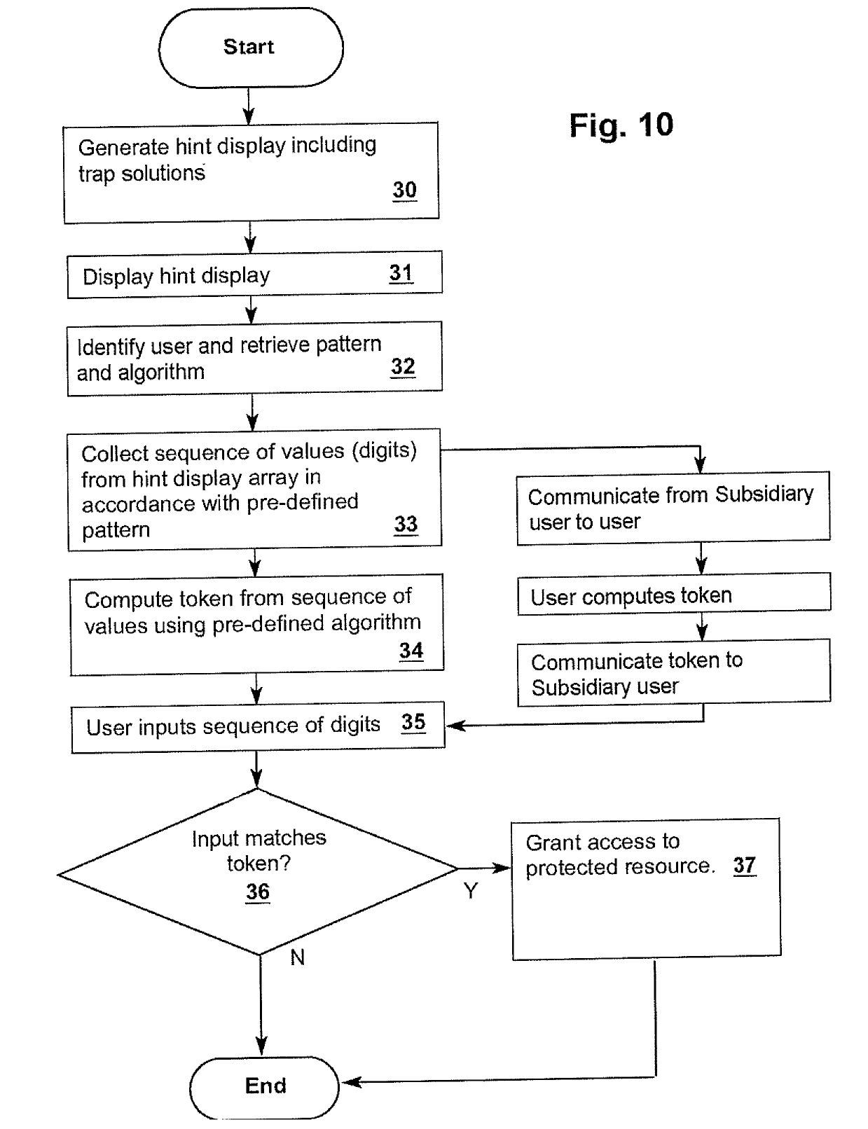

The present invention also provides a mechanism, as shown in FIG. 10, for sharing access information on a one-time basis without compromising the underlying pattern and algorithm. If the owner of the access pattern and algorithm knows a particular hint display, then another person can be told the resulting input token without compromising the pattern/algorithm combination.

In other words, a second subsidiary user can be allowed to obtain access to the resource for a session by the steps of:

communicating the hint display including the set of elements for the session to the subsidiary user;

causing the subsidiary user to communicate the set of elements to the user;

causing the user to use the predetermined protocol and the predetermined operation to compute the token;

causing said user to communicate the token, without the predetermined protocol and the predetermined operation, to the subsidiary user so as to enter the computed token into the user interface;

causing the system to effect a comparing of said token received with at least one corresponding token generated by the authentication system;

and selectively providing access by the user to said resource for said session in conformity with a matching result of said comparing.

For example in the past the user might have been away from the office, been contacted and asked to give someone else access to one of the protected systems. In a situation like this the user has only two choices; (a) divulge the secret password; leaving the security compromised, or (b) refuse the request. It is impossible to share passwords in a secure manner.

In the present arrangement, the user may be asked to provide someone else with access to the system. In a situation like this the user now have an additional choice; (c) ask for the numbers in the clue table, compute the token yourself, and then response with the one-time token. The secondary user back at the office can access the system once and only one. This option provides a completely new level of flexibility that passwords cannot deliver. The only restriction is that this process should only be used sparingly, otherwise the assistant could collect data from multiple event and identify the pattern and operation involved.

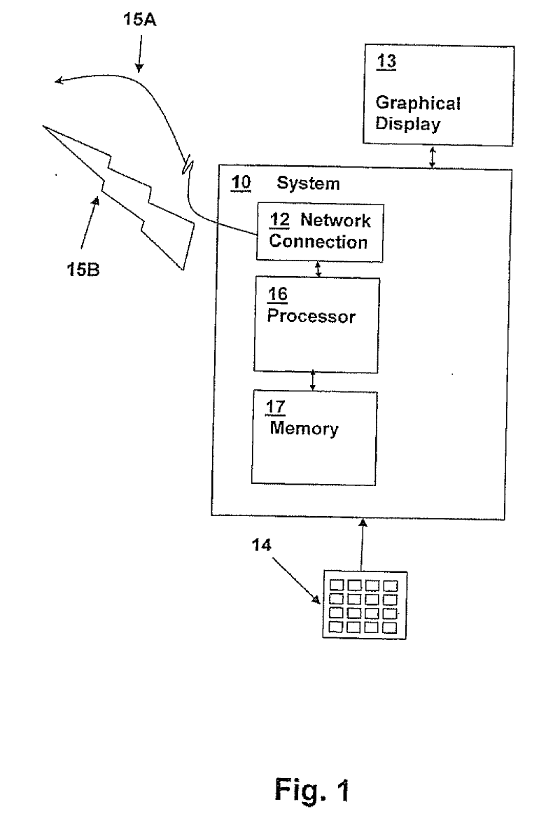

Referring now to the figures, and in particular to FIG. 1, a networked system within which embodiments of the present invention may be practiced is depicted in a block diagram. The depicted system 10 is representative of a general class of computing devices that include a processor 16 and a memory 17 coupled to processor 16 for storing data and program instructions for execution by processor 17. A graphical display 13 is coupled to system 10 and may in fact be integrated within the same housing, as will generally be the case with ATMs and portable devices such as notebook/tablet computers and personal digital assistants (PDAs). A keyboard or keypad 14 is also coupled to (or integrated within) system 10 to receive user input in accordance with an embodiment of the present invention. A pointing device may be used as an alternative, but as will be noted below, using a pointing device for input requires that elements for all input values be present on the screen of graphical display 13, whereas with a keyboard or keypad, the values need not be present on the screen.

A network connection 12 implements either a wired 15A or wireless 15B interface to processor 16 and although a network connection is not a requirement of the present invention, devices such as ATMs generally require some form of networking for financial access operations.

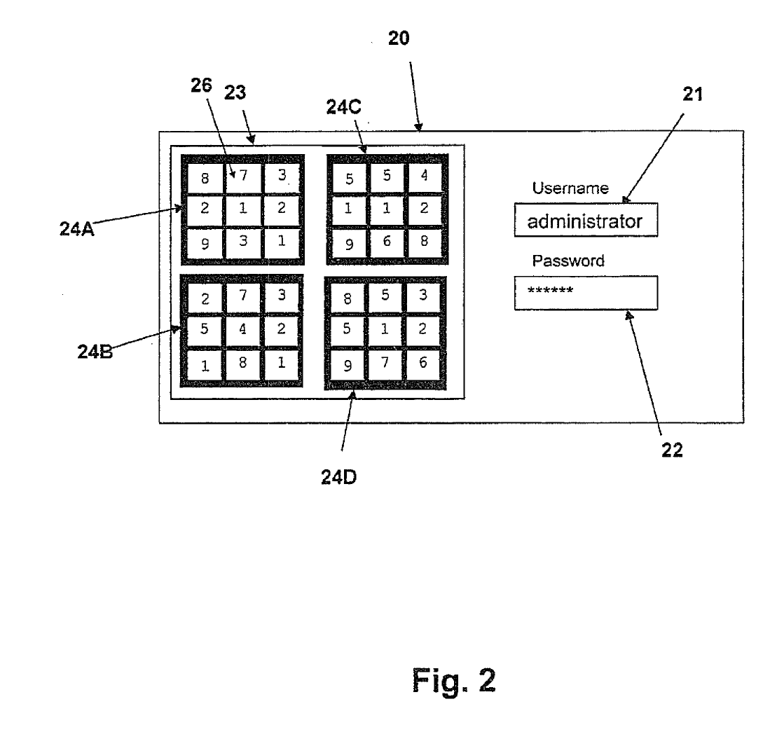

Referring now to FIG. 2, a user interface in accordance with an embodiment of the present invention is depicted as a screen 20 of graphical display 13. A hint display 23 made up of four 3×3 sub-arrays 24A-D is shown. Each sub-array contains a plurality of elements 26, each of which has a unique position within hint display 23. Each of elements 26 also has an associated value that may or may not be unique. In the illustrative example, the value is the numerical value of the digit displayed on the face of each element 26. However, the present invention is not limited to numerical digits and the values do not have to match the displayed information on the corresponding elements. For example, graphical icons may be used instead of numbers, selection made via a pointing device and the hidden algorithm that is combined with the selection sequence may be a logical operation that combines the information provided one or more of the icons in a logical fashion.

Also, while a single array may be used to implement the present invention, use of sub-arrays provides another level of hint to the user in that the four sub-arrays shown can be presented in any arrangement on the screen 24A-D. The user determines the proper sub-array 24A-D for each element the user enters by a clue unique to each sub-array 24A-D such as a unique color of a frame around each sub-array or the color of the values (e.g., digits) displayed on the individual elements 26. Screen 20 also includes fields 20,21 for entry of a username and password, as are generally found on login screens and the like. However, entry fields are not a requirement of the present invention and screen 20 may consist solely of hint display 23, particularly when all values to be entered have corresponding elements present on screen 20, in which case a pointing device such as a mouse or touch screen may be used to implement the input device that receives the token sequence. User identification field 20 is not needed if the user is known a priori, if the pattern/algorithm is common to all users, or if a more relaxed security scheme is tolerable in which multiple tokens are permitted and used via matching to identify the user.

Elements 26 of sub-arrays 24A-D can be randomly or quasi-randomly generated to initialize the array. If so, a pattern of elements 26 is used to select a sequence of values from the elements 26 that will correspond to the correct sequence of elements known by the user. Alternatively, a sequence of elements can be generated, “seeded” in the pattern locations, and then other randomly generated “don't care” values can be filled in the other element 26 locations in sub-arrays 24A-D. If hint display 23 is divided into sub-arrays, then the sequence must also take into account the proper placement in the correct sub-array for each element. For example, if sub-arrays 24A-D are colored respectively: {red, blue, yellow, green}, and the proper element sequence known by the user is top row red, middle row blue, then the sequence according to the illustrated hint display 23 is 8,7,3,5,4,2 assuming left-to-right reading of the row.

The next portion of the security mechanism implemented by the present invention is the combination of the sequence values using a hidden algorithm (as opposed to the visible pattern illustrated above). The selected sequence is then operated on by at least one operator in at least one operation. The operators may be mathematical operators such as addition, subtraction, multiplication and division, an identity (or “copy” or “repeat”) operator that yields the value of the element, or relational operators such as “the smaller of” or “the greater of” and may operate on two or more elements or in some cases only one. Not all of the operations are identity operations, or the algorithm would not be hidden and would merely reveal the sequence above, although a system in accordance with an embodiment of the present invention can additionally implement a “non-hidden” algorithm as an option having a lowered security level. A non-hidden algorithm is provided by a sequence of identity operators, one for each element in the pattern, such that the output of the algorithm is identical to the input sequence. Hidden constants may also be employed in combination with the above operators, for example “add 1 to each digit” or “enter digit if>4” and similar other rules.

As an example of a relational operation, using the above-recited example as the sequence, the algorithm could be return the lowest element of each of the rows, in which case the proper token input would be 3,2. As another example, the algorithm may be add the first two elements of the row for a first value and use the third element for a second value, in which case the correct token would be 15,3,9,2. Operations/algorithms can extend between the sub-arrays, as well. For example, the algorithm may be multiply each element in sequence from the first sub-array with each element from the second sub-array and use those as a token string. The proper token for the above example sequence would be 40,28,6.

As illustrated by the examples, very complex and strong mechanisms may be implemented by the present invention, depending on the relative complexity of the hint display, which may be made arbitrarily large, values of the elements, which may also have arbitrarily large ranges, and the complexity of the algorithms employed. In general, there is a direct trade-off of the ease with which a pattern and algorithm can be memorized and the level of security afforded by the particular combination.

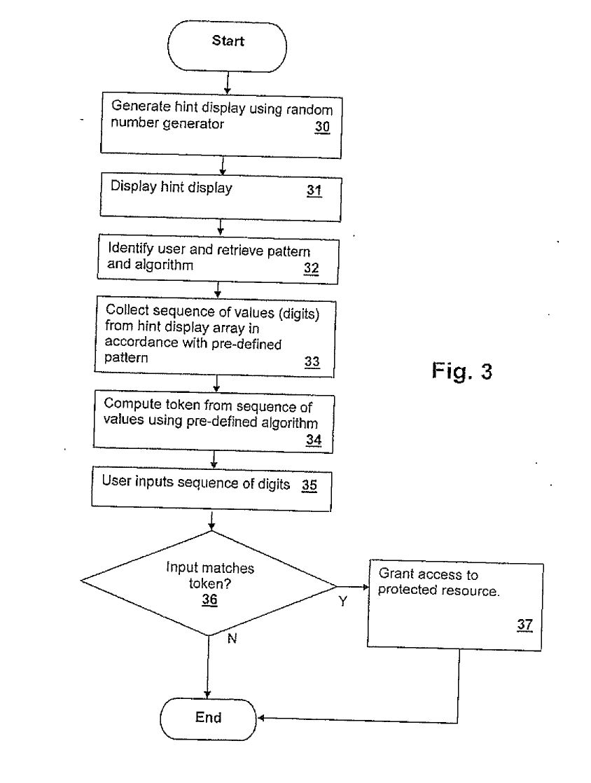

Referring now to FIG. 3, a flowchart illustrating a method in accordance with an embodiment of the present invention is depicted. The method may be implemented by program instructions executing within a computing device such as a personal computer, workstation or dedicated terminal such as an ATM. The program instructions may be embodied in a compute program product comprising media encoding said program instructions. A hint display is generated using a random number generator (step 30) and the hint display is displayed (step 31). The user is then identified via the userID input field 20 and the user's pattern and algorithm are retrieved from storage (step 32). Next, the sequence of values from the hint display are collected in accordance with the predefined pattern of elements (step 33). The token is then computed using the collected values according to the pre-defined algorithm (step 34). When a user inputs a sequence of digits (step 35) the sequence is compared against the token values computed in step 33 and if the input sequence matches, (decision 36), then access to the protected resource is granted (step 37).

A control panel for configuring the algorithm and pattern is also provided in accordance with another embodiment of the present invention, and may be graphically or textually implemented. Graphical control panels will generally permit selection of the pattern sequence via a pointing device and then assign rules to combinations of values or individual values from the elements in the pattern. A textual control panel can accept a string that describes the pattern and algorithm, for example by using the matrix positions as subscripts, each element can be uniquely identified by a position number. Operators can be given their own symbols such as “R” for replicate, “+” for sum, “×” for multiply, “S” for “smaller of” and so forth. Any sub-arrays while arranged in their “native” order can be combined in one matrix for the purposes of encoding the string.

For example, if the position numbers are assigned left-to-right across rows and descending through the hint display, the above-exemplified algorithm multiplies each element in sequence from the first sub-array with each element from the second sub-array and use those as a token string, could be encoded as: “E1×E25,E2×E26,E3×E27”, where × is the “multiply” operator. (Elements 25-27 correspond to the middle row of sub-array 24B as used in the example above.)

### Set Up Program

The Set up program is primarily designed to construct the pattern and calculation combination of the token for users who choose not to create their own. However, everyone could benefit from trying the set up program. This is because the pattern styles found in the set up program could enrich styles already known by the user. Also, users whose first choice is to use their own construction, may find some of the Set up program styles complementary to their own Pattern and calculation combination.

The set up program is capable of constructing over 1,000,000 simple pattern and calculation combination If multiple pattern and calculation combinations are combined together, the number of unique combinations would easily exceed 10,000,000,000,000.

The set up program is run by selecting a few attributes and then choosing a style. The entire process takes only a few minutes to complete. Like the manually created pattern and calculation combination, the set up program also requires you to pass a simple test before your new pattern and calculation combination becomes active.

### Difficulty

The first question asked by the set up program determines how difficult to make the pattern and calculation combination. Since this option controls the overall pattern and calculation combination complexity, this attribute is the only one which does not allow a random choice to be made.

The purpose of the ‘Difficulty’ setting is to filter-out inappropriate attribute values for each of the attribute questions. If the user chooses an ‘Easy’ difficulty level, for instance, then the larger dimensions and the harder operators would be removed from possible use.

It is important to realized that a pattern and calculation combination created with an ‘Easy’ setting may be just as secure as one create with a ‘Hard’ setting it would just be longer (more sub-rules). However, in general, easy pattern and calculation combinations are longer, and take a bit more time to type than hard pattern and calculation combinations.

There are 4 distinct difficulty levels used:

1. Very Easy—Suggested for users who prefer the simplest possible Pattern and calculation combination. This level is intended for the 20% of the population who might say they ‘hate’ math.

2. Easy—Recommended for users who wish to avoid most mental arithmetic. Contains some calculation combinations, but these are kept to a strict minimum. This level is intended for the next 30% of the population.

3. Hard—Recommended for most users who can easily perform basic arithmetic in their heads, and can also easily keep track of positions. This is intended for the next 40% of the population

4. Very Hard—Only for users who can quickly (and accurately) multiply long series of numbers in their head, and also prefer the enhanced security this provides. This is intended for the top 10% of the population.

### Style

The second question relates to the style of the pattern and a number of arrangements are possible.

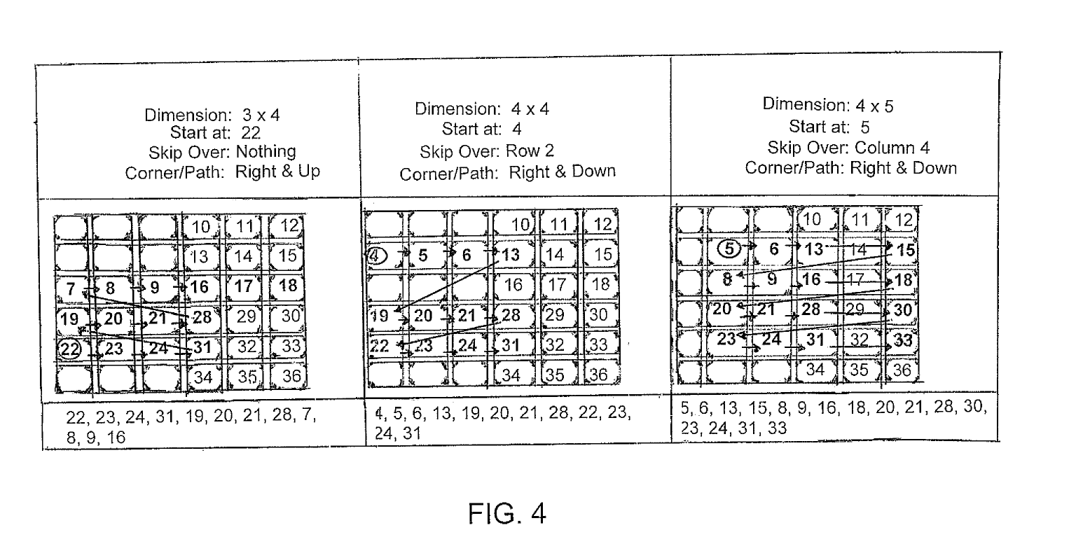

1. Array Style. This style describes a variety of combinations where the cells are placed in a rectangular (or array) pattern. These arrays must reside entirely within the bounds of the clue table (ie. not wrap across any edges). To add an extra layer, individual rows or columns may sometimes be omitted. Examples are shown in FIG. 4.

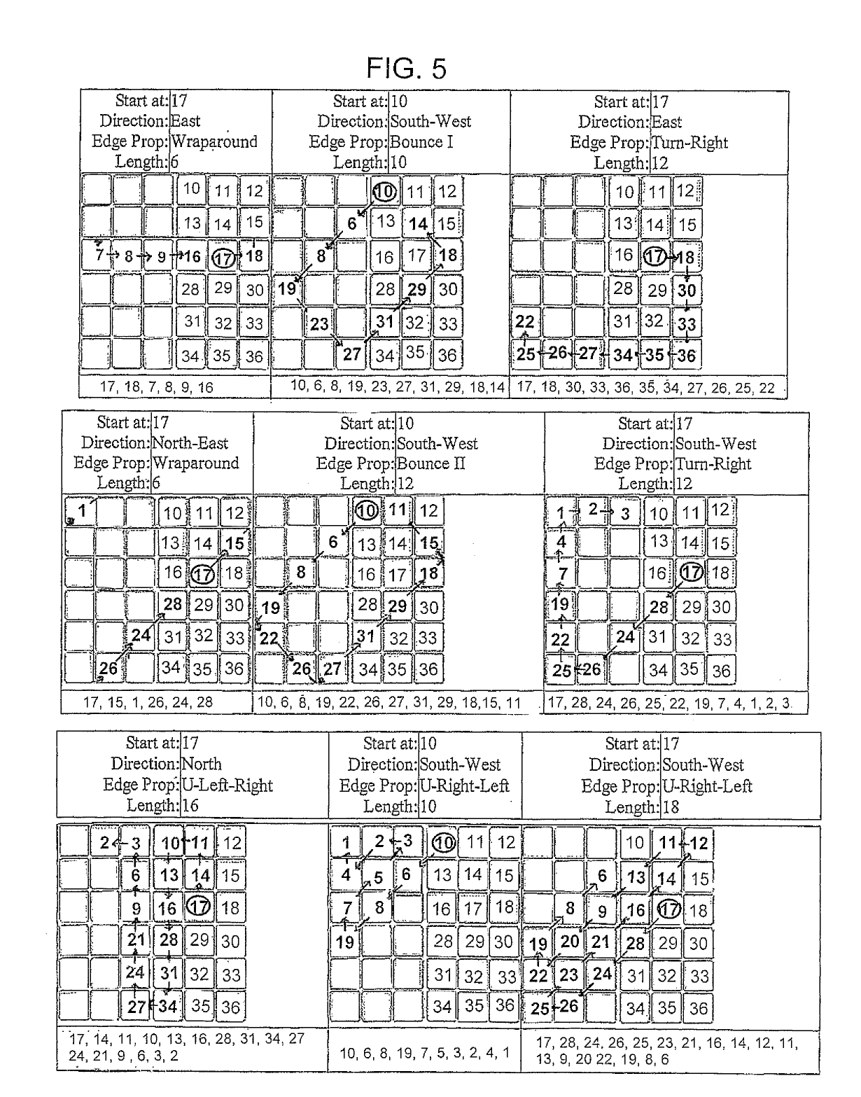

2. Line Style. This style describes a series of cells that form a single line. However, not all lines are perfectly straight. Directions are always either a row, a column, or some diagonal. Lines may go off one edge and wraparound, bounce off an edge, or make turns. Bounces can touch one or two values near the edge, trace along a wall, or backtrack (U-turns). Examples are shown in FIG. 5.

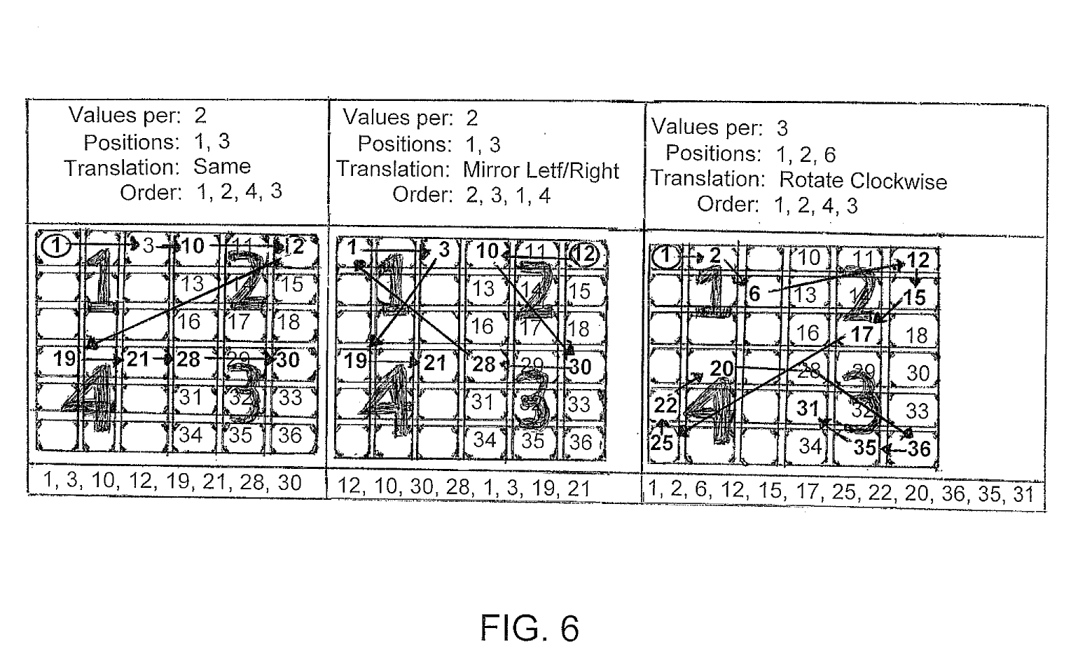

3. Quadrant Style. This style starts with any collection of cells within one (3×3) quadrant, and then translates this patterns into the other 3 quadrants, using a variety of translation and ordering parameters. Examples are shown in FIG. 6.

4. Shape Style. This style takes its name from a ‘drawn’ shape such as a letter, number, or some specially drawn line. An example of this would be the letter ‘N’ (as shown in the examples below). Examples are shown in Figure X.

5. Pair Style. This style takes the form of ‘n’ combinations of paired cells. When pairing, the consecutive cells are either all horizontally touching, or all vertically touching. Horizontal and vertical are never mixed.

### Variable Security Methods

There are a number of examples of security level adjustment methods, set out as follows:

| | Security Level | | |
|---|---|---|---|
| | Lowered | Regular | Enhanced |
| 1. Changing Clue Table Values | 1 . . . 5 | 1 . . . 9 | 0 . . . 12 |
| 2. Truncation | Yes | No | No |
| 3. Clue Table Fixing | Yes | Yes | No |
| 4. Remapping | No | No | Yes |
| 5. Cycling | No | No | No |

1. Changing Clue Table Values. This has the effect that it acts to lowers and enhances security. This technique works by modifying the range of numbers that are shown in the clue table. For example, using only the digits 1, 2, or 3 instead of the numbers 1 through 9 significantly reduces the security, but it also reduces the effort as well. Most operations (especially the arithmetic ones) become significantly easier to perform on lower numbers (‘2×3’ is obviously easier to answer than is ‘8×9’). However, since the set of unique single-use tokens is greatly reduced, the chance of a hacker compromising the Pattern and calculation combination is correspondingly increased. The following table shows the numbers of total unique combinations for a set of Clue Value Ranges. Combinations for Various Clue Value Ranges (abridged)

| Clue | | | | | |
|---|---|---|---|---|---|
| Value | Digits | Unique | Encryption | Security | Example |
| Range | Long | Combs. | Bits | Level | Tokens |
| 1 . . . 5 | 4 | 5.0 × 103 | 12 | Lowered | 8065 |
| 1 . . . 9 | at least 8 | 1.4 × 106 | 20 | Regular | 80658978 |
| 0 . . . 15 | at least 16 | 1.6 × 1031 | 103 | Enhanced | 8065897865468480 |

2. Truncation This has the effect that it acts to lower Security only. In this technique, the system disregards all digits typed after some set limit. For instance, if the truncation value is set to 4, then only the first 4 characters of the token are examined, all subsequent digits are ignored, or prevented from being typed.

This method is an extremely effective for reducing security because it does many things at once:

It is easier to calculate.

It is faster.

Since only part of the rule is utilized, the entire Pattern and calculation combination cannot be compromised

When this method is combined with the next method (clue table fixing), it becomes even more powerful. In the case of a low security system such as a photocopier (in which the clue table might change semi-annually) this method allows the user to easily memorize the short token and only re-examine the clue table twice a year.

3. Clue Table Fixing. This has the effect that it acts to lower Security only. This method involves ‘fixing’ the values shown in the clue table for a set period of time. Instead of generating new clue table values at every login, the clue table values could remain the same. As long as the clue table remains unchanged, the user's pattern and calculation combination is effectively the same as a simple password, which is obviously quick and easy for most users.

It is interesting to note that this particular method could be used to perform a periodic corporate-wide security change, simply by changing the clue table values. An interesting aspect is that it actually reduces the efficiency of a phishing attack since there are fewer unique data observations (since most of the data will be exactly the same). On the other hand, as long as the clue table remains fixed, any discovered token will all system access, even if the pattern and calculation combination itself is not revealed. Which is why the user cannot change their pattern and calculation combination with a ‘lowered’ security login.

4. Remapping. This has the effect that it acts to enhances Security only. This technique involves applying a pattern and calculation combination to two distinct clue tables that are found within an over-sized clue table. In the ‘Setup Utility’, there is a special section called ‘Enhanced Remappings’ and it displays how the user must apply their standard pattern and calculation combination (which normally considers only four quadrants) onto a high-security clue table (containing 9 quadrants).

Quite simply, this is done by looking at only four quadrants at a time and ignoring the other five quadrants. The increased number of clue values is a further source of confusion for any potential hacker.

5. Cycling. This has the effect that it acts to enhance Security only. This technique simply displays the same login dialogue 2, 3 or 4 times, each time the clue table values are randomly generated, each time the user must construct their token and enter the result. Because the user calculates multiple tokens in succession, the number of combinations is greatly increased (if the regular login has N combinations, cycling three times would produce 3×N total combinations).

Since increased combinations result in increased security, the more logins, the less likely a hacker can violate the system by guessing tokens. In the conventional password paradigm this is analogous to having several different passwords, all of which must be entered in the correct sequence.

Obviously, this method cannot be used in conjunction with ‘Clue Table Fixing’ since the token would be the same each time.

This method is not usually recommended since the user effort is significant. Except here, this method is not referenced again.

### Variable Security Frontier

In the world of traditional passwords, it is inconceivable that one password would be used for both the departmental photo-copier and the human resources database. But with a single pattern and calculation combination, this is easily and safely implemented.

To understand how this flexibility works, refer to the figure X. It shows how each authentication method has a measurable ‘Cost’ and ‘Security Strength’ value. For instance, on this graph ‘Strong Passwords’ are further right and higher up than ‘Weak Passwords’. This means that a ‘Strong Password’ is both more costly (in terms of lost productivity and system/administration involvement) and also is more secure (it is harder to crack). Regardless of the technology, the important issue is that each method is a ‘fixed’ point on the graph, that is they never shift or change their cost or security strength values.

Pattern and calculation combinations work very differently. Even though a user remembers the same pattern and calculation combination for every situation, the overall size of the clue table and the values contained within it, affect how much mental effort is needed to compute the token. As the amount of this effort varies, so too, does the ‘Security Strength’. For example, consider the pattern and calculation combination ‘1×2,3×4,5×6’. It makes a big difference to the user if the multiplications are done on small or large numbers (ie. 3 times 2 is easier to compute mentally and produces a smaller number than 9 times 13). So a clue table that only contains ones, twos and threes is a lot easier to work with than one that includes all numbers from 1 to 15.

All of the following methods perform a similar purpose. They reduce or increase the effort to compute the tokens, and at the same time, reduce or increase the numbers of possible tokens (ie. security strength).

The pattern and calculation combinations have other specific features that make them usable for multiple systems with differing security requirements:

1. In general, the pattern and calculation combinations can be used for longer periods than passwords.

2. Security breaches of lowered-security system do not affect the security of other systems.

In summary, the security can be adjusted up or down without changing the pattern and calculation combination itself. For example, ‘Lowered Security’ may be acceptable when tracking photocopier usage, but ‘Enhanced Security’ is needed for the Human Resources system. Regardless, a single pattern and calculation combination can be used in both situations without concern.

Using only the clue table itself (and a few special rules), a single pattern and calculation combination can generate over a hundred security variations. A single pattern and calculation combination can become significantly more secure by applying it against larger clue tables (and other methods). That same pattern and calculation combination could also have its security reduced by using smaller random numbers (and other methods). Instead of just the 3 stated values (Lowered, Regular and Enhanced), there are literally hundreds of distinct values.

To summarize, pattern and calculation combinations do not exist as individual points in our graph. Instead, they can continuously change their ‘Security Strength’ and ‘TCO’ values simply by applying one or more special techniques.

it is important to repeat this concept that all changes occur within the login window, not the pattern and calculation combination. This means that the user need only memorize a single pattern and calculation combination. This is one of the most important features of pattern and calculation combinations and is the only security system in the world with this capability.

Lowering Security

The same window used for the regular login is also used for the lowered security login. There are three defined techniques that reduce the overall security protection, they are:

1. Clue Table Fixing

2. Changing Clue Table Values

3. Truncation

The common example application for this variation is the corporate photo-copier.

### Enhancing Security

A slightly different window is used for enhanced security logins which utilize the ‘remapping’ technique. There are three defined techniques that enhance the overall security protection, they are:

1. Remapping

2. Changing Clue Table Values

3. Cycling

The common example application for this variation is the corporate HR database.

### Implementing a Secure Pattern and Calculation Combination System

The method of how to implement a secure pattern and calculation combination system requires some background on how normal password systems are implemented. Standard Password Systems work so that when a user authorization system is used by any computer system, there is one required component, that is the password file. This file contains valid usernames and passwords for all users. The username is the string the user enters to identify themselves. The password is a secret string of characters which is intended to prove that the user is who they claim to be. Generally therefore, password files have the two columns and contain one row one for each user.

Often there are many other columns such as the user's full name, creation date, active flag, and others. These other columns are irrelevant to the current discussion.

If a hacker somehow obtained a copy of this password file, the hacker could access this system with complete immunity, and his access could not be easily detected. Even though these files are often heavily protected these files have long been recognized as a major weak point in all password protected systems.

To protect this file the standard method is the encryption process. Originally, most encryption processes used the Data Encryption Standard (DES), but nowadays there are better (but largely similar) algorithms.

All encryption algorithms essentially accept a string of characters as the input and produces a seemingly nonsense string. All encryption algorithms all have the following critical features:

a) the same input string always produces the same output string,

b) the relationship between the input and output strings is non-obvious and mathematically hard to predict, and

c) there is no way to reverse the operation (ie. derive the input string from the output string). The only reliable approach is to solve the relationship for all possible input string and creating a “huge” lookup table which is well beyond the storage capabilities of any computer system.

The arrangement of the present invention provides a solution for this problem.

In summary, pattern and calculation combinations are not like static strings and cannot be encrypted or saved in a useful way. And, unless something is done to protect this information, the simple storage of pattern and calculation combination in a data files presents a clear target for hackers to capture.

To best solution to this problem it is to create a large number of predefined combinations (say, one million of them) at the time when a pattern and calculation combination is newly created or changed. Then, when a user attempts to access this system, the following steps occur:

1. the system randomly selects one row out of the million rows,

2. the system reads and displays the clue table values found in this row (36 numbers),

3. the system reads the ‘saved encrypted token’ also found in this row,

4. the user is allowed to enter their token (after applying their pattern and calculation combination to the clue table numbers),

5. the system encrypts the user-entered token to obtain the ‘user-entered encrypted token,

6. the system compares the ‘user-entered encrypted token and the ‘saved encrypted token. If they are the same, access is granted, if they are different, access is denied.

This proposed table might look something like this:

| User- | | | Encrypted |
|---|---|---|---|
| name | Index | 36 Clue Table Values | Token |
| ngoertz | 0 | 5 8 0 2 9 9 5 8 1 5 3 0 8 9 3 3 0 2 6 | 7D74E4569A |
| | | 4 4 9 4 4 7 9 3 8 3 4 1 6 5 4 6 5 | |
| ngoertz | 1 | 7 7 9 3 8 0 5 7 4 3 8 5 6 1 8 6 0 2 5 | 699B1AC433 |
| | | 8 1 3 7 5 6 6 4 6 1 6 8 1 8 8 9 2 | |
| ngoertz | 2 | 2 7 5 1 1 9 9 0 9 6 8 9 4 8 6 0 5 1 0 | 3F2D5B928A |
| | | 1 5 2 0 0 9 2 3 0 1 3 0 7 0 8 0 2 | |
| ngoertz | 3 | 2 4 2 8 7 8 1 6 4 6 8 5 3 8 1 3 5 8 2 | EA41B53E20 |
| | | 5 1 3 2 9 1 7 9 0 9 0 0 6 7 4 1 8 | |
| ngoertz | 999999 | 8 2 1 8 9 6 0 0 4 3 9 0 5 5 8 3 0 3 0 | 5680D0C7F4 |
| | | 2 5 8 5 8 3 1 1 2 2 1 6 4 0 8 3 5 | |

The system may also include the following features:

1. To create a significant hurdle for would-be hackers, the majority of rows should contain erroneous data that the normal random selection process would avoid, but a hacker would have no way of knowing which rows should be ignored.

2. The process of selecting a row at random should follow a hidden and pre-determined sequence so that each row is used only once. This creates a further challenge for any hacker who manages to obtain this protected file since they must then solve (probably using a Brute-force attack) a solution for every row and store all results for later retrieval.

Thus the system herein includes for each user a table storing information for providing a plurality of separate sets of characters and, for each separate set of characters, the token obtained by selecting the subset and carrying out the calculation.

In this way the system and the table therein is arranged such that the system does not store information by which the subset is selected and does not store the calculation. This avoids the possibility that the hacker can gain access to this simple data which would allow the solution in each case to be readily apparent, and also provides additional confusing information which will interfere with the hacker's ability to analyze the data he has found.

in practice the number of entries in the table is selected such that for practical example it is sufficient to provide a different set for each of the sessions expected to be implemented by the user.

Preferably the token is stored in encrypted form. Thus when the token is received from the user, it is encrypted using the same encryption algorithm after receipt and prior to the comparing.

In one arrangement the table actually contains the list of all of the characters to be sent to the display array for the login procedure for each session.

As an alternative, the table merely contains a seed for use in a number generator such that the characters of each set are generated by selecting the seed and by providing the seed to the number generator.

Preferably the table includes additional sets of dummy characters and associated dummy tokens which are never intended to be used for the display and are provided as misleading information for any hacker gaining access to the table.

In order to make matters even more difficult for the hacker, the row in the table containing the information to be used for each session by a user is selected randomly from those rows containing real information ignoring of course the dummy rows. Also the rows from the table are used only once.

### Hacker Traps

This provides a method of recognizing the criminal actions of skilled hackers attempting to gain access to the system, as distinct from the non-criminal mischievousness of risk-seeking adolescents. In the physical world, this distinction is often much easier to understand; the relatively innocent kid might jiggle a few doorknobs to see if a door was inadvertently left unlocked, whereas a criminal carries a set of lock-picking tools. In cyber-space there is a notable shortage of tools that distinguishes kids from criminals, mostly because the act of guessing random passwords is the same technique used by both groups.

In the present system there is provided a component which detects and stops criminally-minded hackers. Individual traps are set and triggered only when someone enters one of the specific trap tokens. These trap tokens are computed with mathematical precision and are almost certainly the result of someone who has illegally collecting login data from past legitimate users.

Although hacker traps are not difficult to explain at a conceptual level, the specific processes can be somewhat intimidating.

Assume that instead of a normal password users apply a simple rule which states their password are the digits ‘1234’ followed by:

1. the day of the month if, and only if, the day is an even number, or

2. the reversed digits of the days of the month if, and only if, the day is an odd number.

Let us assume the user logs into the system on the following days:

1. On the 14th of January the user enters ‘123414’,

2. On the 16th of January the user enters ‘123416’, and

3. On the 18th of January the user enters ‘123418’.

If a hacker were somehow recording these event by recording this user's keystrokes, or video-recording their keyboard, or tapping the communication lines, the hacker might conclude that the password is always the digits ‘1234’ followed by the day of the month. His conclusions are reasonable, but not correct since he did not observe the user logging into the system on an odd numbered day. Therefore, if the hacker tries to break into the system on the 19th of January, he would (incorrectly) type ‘123419’, even though the correct password should be ‘123591’.

If we can assume (and we do so only for this argument) that the user would never forget their rule and would always reversed the digits on odd-numbered days, then the only other explanation when the system sees this bad password is that there was a hacker who observed previous login events and somehow failed to get the rule exactly correct. A serious and criminal hacker is found.

Although the exact mechanisms are somewhat different, this is how hacker traps work in general. Would-be hackers collection information from legitimate users, they draw imperfect conclusions that seem to make sense, and they react by breaking into the system. And, in the majority of cases, are immediately recognized as being criminal behaviours.

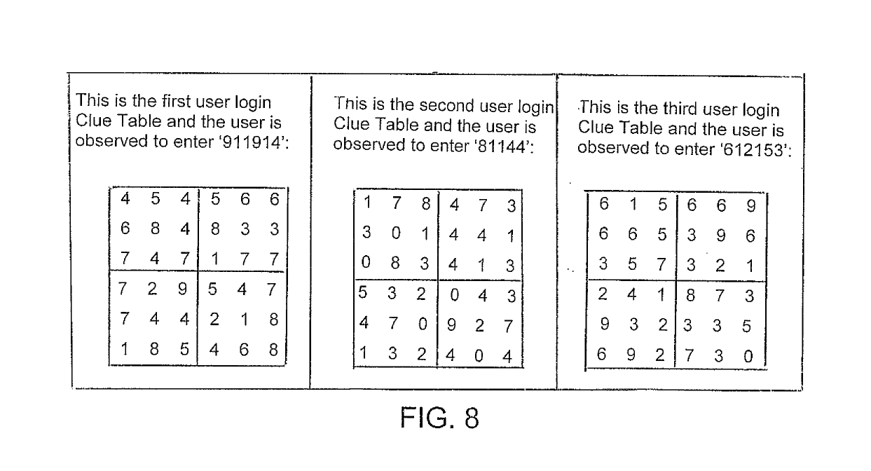

A real example of how this operates may be as shown in FIG. 8 where the patterns and calculation for three successful logins are shown.

If a careful analysis of these three successful logins is performed we find there are (at least) three distinct and separate pattern and calculation combinations which could produce these three recorded tokens.

They are (in no particular order):

1. (1)+(2), (8)+(9), (28)+(29), (35)+(36)

2. (16)+(13), (10)+(11), (12)+(15), (18)+(17)

3. (20)+(19), (22)+(23), (26)+(25), (21)+(27)

Note that there may be other pattern and calculation combination which could produce the same tokens, however this discussion is focused only on the three shown here.

Hackers know that every attempt at collecting user login data corresponds to some risk. That is, the key-logging program may be discovered, the camera may be found, the line tap may set off an alarm, and they may all lead back to them. When faced with the risk of collecting more data (which could take months or even years) many hackers will take the chance and pick a rule at random.

Similarly the analysis done by the hacker may have been imperfect and they only found one possible pattern and calculation combination that fits the data. Regardless, they attempt to crack the system on their own and, according to strict probability laws, choose the wrong pattern and calculation combination and therefore the wrong token. Because ‘hacker traps’ are active they are immediately detected, stopped and also possibly sought after by the authorities.

Thus when the hacker trap system is on operation, the characters or values of the elements of the set generated for the session in question are selected so that there are additional valid solutions of patterns and operations which generate the same correct token. That is the token stored in the table previously generated by the authentication system is also generated from the characters or values of elements of the array which are selected from at least one additional subset from the array, which additional subset is different from said subset selected by the user. These additional solutions act as traps because the hacker will find a solution which generates the token but it is likely to be statistically the wrong solution. In this way when the hacker next time enters what he thinks is the correct solution it will be wrong because that solution does not work with the next set of elements. The system will detect that a wrong token has been entered. It will also detect that the wrong token is not merely a mistaken attempt or a random guess which would have a random error. It will detect that the wrong token has been calculated by a hacker to be a solution of the array, just the wrong solution.

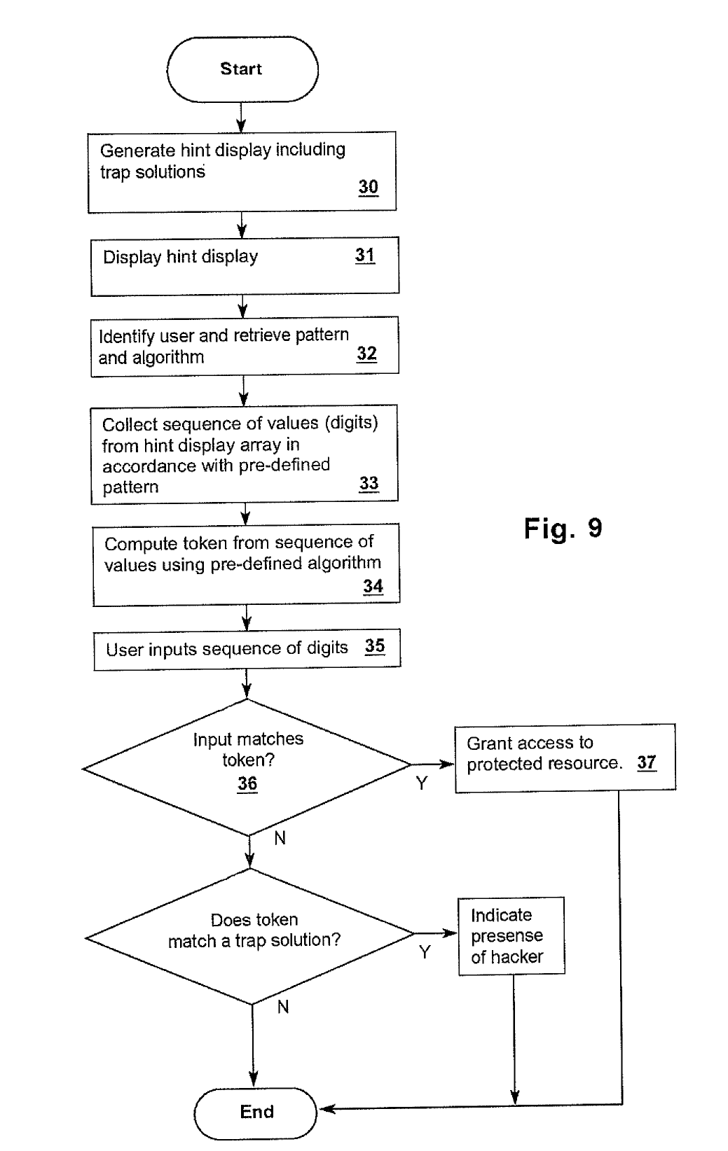

The system is then arranged, as shown in FIG. 9, to generate an output indicative of the presence of a hacker on receipt of the calculated erroneous token.

While it is possible to use a system which has only one additional wrong solution, it is of course much preferred that the number of wrong solutions is much greater than one and typically as much as eight so that the statistical chance of the hacker picking the correct solution is low.

Preferably the characters are arranged so that only the subset is different but also the calculation carried out on the characters or values for that subset is different from the calculation for the different subset. That is where the characters are numerical values the same numbers are not merely repeated in the array but the numbers are different so that the calculation necessary to reach the string of numbers forming the token is different. For example where the calculation is based on each numerical value plus 1, the different calculation may be the numerical value plus 2 so that the values in the pattern or subset are different.

In some cases, the erroneous patterns and calculations may be presented in only one set. However, in case the hacker is monitoring repeated login procedures for different sessions, the erroneous patterns and calculations may be consistent for a series of log in procedures. In this way the hacker becomes confident that his erroneous solution is in fact correct. After that series however the arrangement is changed so that erroneous solution is no longer correct thus causing the hacker to fall into the trap and give away his presence.

Unfortunately, there is also the possibility that they guess the correct pattern and calculation combination, enter the correct token and are allowed access to the system. However, as long as the possibilities are kept small, say 1 chance in 8 or less during a contiguous sampling period, their chances are rarely very good. And therefore their chances of being caught are also, very good.

While the invention has been particularly shown and described with reference to the preferred embodiments thereof, it will be understood by those skilled in the art that the foregoing and other changes in form, and details may be made therein without departing from the spirit and scope of the invention.

1. A method for allowing access to a resource for a plurality of separate user sessions by a user comprising:
wherein the method is carried out by an authentication system having a user interface with a display viewable by the user and an input for entry of data by the user;
the system being arranged for each session to generate a hint display made up of a set of elements;
the set of elements including a sub-set of elements;
causing the sub-set to be predetermined prior to the sessions in communication between the system and the user;
the set of elements defining individual characters;
the characters of at least some of the elements of the set being changed for at least some of the sessions;
displaying said hint display including the set of elements to said user;
to commence a session, causing said user to compute a token from the characters of the elements of the sub-set of said hint display generated for that session;
causing said user to enter the computed token into the user interface;
causing the system to effect a comparing of said token received with at least one corresponding token generated by the authentication system;
and selectively providing access by the user to said resource for said session in conformity with a matching result of said comparing;
and during computing of the token causing said user to perform at least one operation on said character of said at least one of said elements of said predetermined sub-set such that the token comprises at least one hidden character which is not identical to the character of said at least one of said elements upon which the operation is performed.

2. The method according to claim 1 wherein the subset is determined in the set by displaying the set in a predetermined array and by providing the subset as a predetermined pattern in the array of selected ones of the elements of the array with each element in the predetermined pattern having a unique position characteristic in the array.

3. The method according to claim 1 wherein the characters are numerical values.

4. The method according to claim 1 wherein the operation is carried out by an arithmetic operation on a numerical value forming at least one of the characters.

5. A method for allowing access to a resource for a plurality of separate user sessions by a user comprising:
wherein the method is carried out by an authentication system having a user interface with a display viewable by the user and an input for entry of data by the user;
the system being arranged for each session to generate a hint display made up of a set of elements;
the set of elements including a sub-set of elements;
causing the sub-set to be predetermined prior to the sessions in communication between the system and the user;
the set of elements defining individual characters;
the characters of at least some of the elements of the set being changed for at least some of the sessions;
displaying said hint display including the set of elements to said user;
to commence a session, causing said user to compute a token from the characters of the elements of the sub-set of said hint display generated for that session;
causing said user to enter the computed token into the user interface;
causing the system to effect a comparing of said token received with at least one corresponding token generated by the authentication system;
and selectively providing access by the user to said resource for said session in conformity with a matching result of said comparing;
wherein the subset is determined in the set by displaying the set in a predetermined array and by providing the subset as a predetermined pattern in the array of selected ones of the elements of the array with each element in the predetermined pattern having a unique position characteristic in the array;
and wherein the array includes a plurality of sub-arrays where each of the sub-arrays is visually distinguished from the others.

6. The method according to claim 5 wherein the sub-arrays are distinguished from each other by color.

7. The method according to claim 5 wherein each of the sub-arrays is a 3×3 array of the positions.

8. The method according to claim 5 wherein the characters are numerical values.

9. The method according to claim 5 wherein the calculation is carried out by an arithmetic operation on a numerical value forming at least one of the characters.

10. The method according to claim 5 wherein during computing of the token said user performs at least one operation on said character of said at least one of said elements of said predetermined sub-set such that the token comprises at least one hidden character which is not identical to the character of said at least one of said elements upon which the operation is performed.

11. A method for allowing access to a resource for a plurality of separate user sessions by a user comprising:
wherein the method is carried out by an authentication system having a user interface with a display viewable by the user and an input for entry of data by the user;
the system being arranged for each session to generate a hint display made up of a set of elements;
the set of elements including a sub-set of elements;
causing the sub-set to be predetermined prior to the sessions in accordance with a predetermined protocol in communication between the system and the user;
the set of elements defining individual characters;
the characters of at least some of the elements of the set being changed for at least some of the sessions;
displaying said hint display including the set of elements to said user;
to commence a session, causing said user to compute a token by applying a predetermined operation on the characters of the elements of the sub-set of said hint display generated for that session;
causing said user to enter the computed token into the user interface;
causing the system to effect a comparing of said token received with at least one corresponding token generated by the authentication system;
and selectively providing access by the user to said resource for said session in conformity with a matching result of said comparing;
wherein a level of security provided to the system by the token is varied without changing the predetermined protocol or the predetermined operation.

12. The method according to claim 11 wherein the subset is determined in the set by displaying the set in a predetermined array and by providing the subset as a predetermined pattern in the array of selected ones of the elements of the array with each element in the predetermined pattern having a unique position characteristic in the array and wherein the level of security provided by the token is varied by truncating the pattern so as to reduce the length of the token.

13. The method according to claim 11 wherein the characters are numerical values allowed over a range of numerical values and wherein the level of security provided by the token is varied by changing the range of numerical values allowed for each element.

14. The method according to claim 11 wherein the set is displayed as an array and wherein the level of security provided by the token is varied by maintaining the array constant over a plurality of sessions.

15. The method according to claim 11 wherein the subset is determined in the set in accordance with said predetermined protocol by displaying the set in a predetermined array and by providing the subset as a predetermined pattern in the array of selected ones of the elements of the array with each element in the predetermined pattern having a unique position characteristic in the array.

16. The method according to claim 11 wherein the characters are numerical values.

17. The method according to claim 11 wherein the predetermined operation is an arithmetic operation on a numerical value forming at least one of the characters.

18. The method according to claim 11 wherein the operation on said character of said at least one of said elements of said predetermined sub-set is arranged such that the token comprises at least one hidden character which is not identical to the character of said at least one of said elements upon which the operation is performed.

19. A method for allowing access to a resource for a plurality of separate user sessions by a user comprising:
wherein the method is carried out by an authentication system having a user interface with a display viewable by the user and an input for entry of data by the user;
the system being arranged for each session to generate a hint display made up of a set of elements;
the set of elements including a sub-set of elements;
causing the sub-set to be predetermined prior to the sessions in accordance with a predetermined protocol in communication between the system and the user;
the set of elements defining individual characters;
the characters of at least some of the elements of the set being changed for at least some of the sessions;
displaying said hint display including the set of elements to said user;
to commence a session, causing said user to compute a token by applying a predetermined operation on the characters of the elements of the sub-set of said hint display generated for that session;
causing said user to enter the computed token into the user interface;
causing the system to effect a comparing of said token received with at least one corresponding token generated by the authentication system;
selectively providing access by the user to said resource for said session in conformity with a matching result of said comparing;
and allowing a second subsidiary user to obtain access to the resource for a session by:
communicating the hint display including the set of elements for the session to the subsidiary user;
causing the subsidiary user to communicate the set of elements to the user;
causing the user to use the predetermined protocol and the predetermined operation to compute the token;
causing said user to communicate the token, without the predetermined protocol and the predetermined operation, to the subsidiary user so as to enter the computed token into the user interface;
causing the system to effect a comparing of said token received with at least one corresponding token generated by the authentication system;
and selectively providing access by the user to said resource for said session in conformity with a matching result of said comparing.

20. The method according to claim 19 wherein the subset is determined in the set in accordance with said predetermined protocol by displaying the set in a predetermined array and by providing the subset as a predetermined pattern in the array of selected ones of the elements of the array with each element in the predetermined pattern having a unique position characteristic in the array.

21. The method according to claim 19 wherein the characters are numerical values.

22. The method according to claim 19 wherein the predetermined operation is an arithmetic operation on a numerical value forming at least one of the characters.

23. The method according to claim 19 wherein the operation on said character of said at least one of said elements of said predetermined sub-set is arranged such that the token comprises at least one hidden character which is not identical to the character of said at least one of said elements upon which the operation is performed.

24. A method for allowing access to a resource for a plurality of separate user sessions by a user comprising:
wherein the method is carried out by an authentication system having a user interface with a display viewable by the user and an input for entry of data by the user;
the system being arranged for each session to generate a hint display made up of a set of elements;
the set of elements including a sub-set of elements;
causing the sub-set to be predetermined prior to the sessions in accordance with a predetermined protocol in communication between the system and the user;
the set of elements defining individual characters;
the characters of at least some of the elements of the set being changed for at least some of the sessions;
displaying said hint display including the set of elements to said user;
to commence a session, causing said user to compute a token by applying a predetermined operation on the characters of the elements of the sub-set of said hint display generated for that session;
causing said user to enter the computed token into the user interface;
causing the system to effect a comparing of said token received with at least one corresponding token generated by the authentication system;
selectively providing access by the user to said resource for said session in conformity with a matching result of said comparing;
wherein the predetermined protocol and the predetermined operation are provided to the user by the system in communication between the system and the user in response to the selection by the user of a degree of difficulty to be used therein.

25. The method according to claim 24 wherein the subset is determined in the set by displaying the set in a predetermined array and by providing the subset as a predetermined pattern in the array of selected ones of the elements of the array with each element in the predetermined pattern having a unique position characteristic in the array.

26. The method according to claim 24 wherein the characters are numerical values.

27. The method according to claim 24 wherein the calculation is carried out by an arithmetic operation on a numerical value forming at least one of the characters.

28. The method according to claim 24 wherein during computing of the token said user performs at least one operation on said character of said at least one of said elements of said predetermined sub-set such that the token comprises at least one hidden character which is not identical to the character of said at least one of said elements upon which the operation is performed.
